(19) United States
(12) Patent Application Publication
(10) Pub. No.: US 2012/0089921 A1
(43) Pub. Date: Apr. 12, 2012

(54) Cell phone software-customized to serve across the internet as a controller to a computer that is still further connected to the internet, including for interactive gaming

(76) Inventor: Alejandro Bellini, Escondido, CA (US)

(21) Appl. No.: 12/924,921

(22) Filed: Oct. 7, 2010

(51) Int. Cl. G06F 3/01; G06F 15/16

(52) U.S. Cl. 715/740

(57) ABSTRACT

A mobile phone controls across the Internet a computer that is also concurrently connected upon the Internet to at least one server. The server may provide gaming, and computer controlled by the mobile phone user to display a game to this user. Alternatively, the server may provide maintenance, and the computer—which may be remote—controlled by the user to effect maintenance. Further alternatively, a remote computer may be controlled by the user of the mobile phone to process education and entertainment content, providing display information yet again across the interne to one or more displays local, and visible, to the user. By lavish use of Internet communication remote computers of considerable power and communications bandwidth may thus be controlled by a simple programmed mobile phone to process, and to provide, copious information to a local user having but an inexpensive terminal, or Internet-connected display.

### BACKGROUND OF THE INVENTION

1. Field of the Invention

The present invention generally concerns cell-phone-based multimedia controllers, and the use of cell and mobile phones that are capable of establishing persistent Internet connections to control computers that are also on the Internet.

The present invention particularly concerns Internet-connected cell-phones serving as multimedia controllers of computers that are concurrently connected upon the Internet not only to the cell phones, but also to other computers such as servers.

2. Background of the Invention

### 2.1 Previous Internet-Connected Cell Phone Controllers

United States Patent Application 20040259537 to Ackley for a Cell phone multimedia controller discloses a system and method for remotely controlling and interacting with a multimedia device using a mobile phone. This is accomplished by utilizing cell and mobile phones capable of establishing persistent Internet connections. A software application is provided for the mobile phone which receives inputs entered by a user on the mobile phone's keypad and translates the inputs into commands that are recognized by a multimedia device. For example, the multimedia device may be a television, set top box, or a digital video recorder such as a Tivo or ReplayTV. The software application transmits the data input by the user to the device, either directly, or through at least one central server. Mapping of the commands entered on the mobile phone into commands recognized by the remote device may occur on the phone, at a central server, or at the device itself.

Of particular relevance to the present invention, it is stated at paragraph 34, et seq, that: “FIG. 5 illustrates an example of how a user could use a mobile phone to remotely control and interact with one or more of a plurality of devices located within their own home. For example, a home computer running software in accordance with the present disclosure can be connected with a plurality of devices in the user's home. For example, home electronics such as a television, set top box, digital video recorder such as Tivo or ReplayTV, VCR, DVD player or recorder, or home stereo system could be connected to the home computer. Furthermore, home appliances such as light systems could be controlled.

“Software resident on the home computer could also be accessed.

“For example, a game present on a computer could be played remotely by using one's mobile phone. In an exemplary embodiment, a Java enabled mobile phone such as the Motorola i85s phone, and a J2ME application running on the phone acts as a game controller for an application running on a PC. For example, the phone application connects by way of a small server program to a simple flash movie. The movie is of an airplane flying. Pressing buttons on the phone sends messages to the running Flash movie. These messages cause the plane to slow down or speed up, move up and down and fire a missile.”

However, it will soon be seen that this particular prior art patent is distinguished from the present invention in that it next describes, starting at paragraph 37, that: “Furthermore, the number of players allowed to participate in game play can be increased. For example, if 10 people are playing a spaceship shooting game, player 5 controls the red spaceship. Player 5 presses the “Fire” button on his mobile phone (for argument's sake, the “#” key). The application interprets the key-press as hex identifier 0x23. This is sent via IP to the multimedia computer running the game. The application running on the computer knows that it has received the “Fire” command from the IP address of player 5 and fires the lasers on the red spaceship. Because there is two-way communication between the mobile phone and the computer, the computer can send messages back to the mobile phone. In the spaceship example, the multimedia computer might send data used to simulate radar images of nearby opponents.”

Notably, and by way of example, the cell phone in accordance with the present invention will not be used to view simulated “radar images of nearby opponents, nor anything equivalent, game play being viewed solely on a computer monitor or other connected device, such as a television.

2.2 Remote Control of One Computer from Another

The remote control of one computer from another is known.

As reported circa 2010 in the entry “Remote desktop software” appearing in Wikipedia, the free encyclopedia of the Internet, “[i]n computing, the term remote desktop refers to a software or an OS feature allowing applications, often including graphical applications, to be run remotely on a server, while being displayed locally. Remote desktop applications have varying features. Some allow attaching to an existing user's session (i.e. a running desktop) and “remote controlling” it in front of the user's eyes. Taking over a desktop remotely is a form of remote administration.

“It can also be explained as remote control of a computer by using another device connected via the interne or another network. This is widely used by many computer manufacturers (DELL, HP etc.) and large businesses' help desks for technical troubleshooting of their customers' problems. Windows XP, Vista, and Server 2003/2008 include Remote Desktop Services; Apple includes Screen Sharing with Mac OS X but sells its Apple Remote Desktop separately. There are various professional third-party, open source and freeware remote desktop applications, some of which are cross-platform across various versions of Windows, Mac, and UNIX/Linux/BSD.

“Typical commercial programs used for controlling Windows PCs include LogMeIn, GoToMyPC, NTRsupport, Radmin, TeamViewer, NetSupport Manager, pcAnywhere, I'm InTouch and Laplink. For Macintosh computers, there is Apple Remote Desktop and Timbuktu (Timbuktu also works under Windows). There is also open source remote control software such as many variants of VNC (Virtual Network Computing), and FreeNX. Another solution is a Web control, where you can use your computer anywhere and any platform, is a FogCreek-like solution.

For example, the LiteManager Pro software performs this function. In operation of this software a user sees in a window the desktop of the remote computer and can manage this remote computer with the local mouse and keyboard. The program consists of two parts: the client module LiteManager Viewer installed on the administrator's computer and the server module LiteManager Server installed on remote computers. To add a new connection in the list LiteManager Viewer only need to specify its IP address and can connect to the type specified when installing LiteManager Server password. Interface of the program is as user-friendly as possible. You can reposition panels the way you like, while the most important elements are positioned separately and are easily accessible. The list of remote computers can be displayed in different styles: as thumbnails that can be zoomed, as regular icons or as a table. Different computers will be displayed differently depending on their status. A computer that is off will be displayed in the Online status, if no ROM Server is running or installed on the remote computer, the status will be Not Found, in case a connection is not authorized on the server, the icon will have the Locked status. LiteManager Free allows you to get reliable information about the current status of the computer and about what is going on it at the moment. You will easily learn how to use the interface and realize how comfortable and easy to use LiteManager Free is after you work with it for a while.

Continuing in Wikipedia, a remote desktop is realized when “ . . . the controlling computer displays a copy of the image received from the controlled computer's display screen. The copy is updated on a timed interval, or when a change on screen is noticed by the remote control software. The software on the controlling computer transmits its own keyboard and mouse activity to the controlled computer, where the remote control software implements these actions. The controlled computer then behaves as if the actions were performed directly at that computer. In many cases the local display and input devices can be disabled so that the remote session cannot be viewed or interfered with.

“The quality, speed and functions of any remote desktop protocol are based on the system layer where the graphical desktop is redirected. Software such as PC Anywhere, VNC and others use the top software layer to extract and compress the graphic interface images for transmission. Other products such as Microsoft RDP, Graphon GO-Global and others use a kernel driver level to construct the remote desktop for transmission.

“A main use of remote desktop software is remote administration. However, remote desktop software can also be used for “headless computers”: instead of each computer having its own monitor, keyboard, and mouse, or using a KVM switch, a monitor, keyboard and mouse can be attached to one computer with remote control software, and headless computers controlled by it. The duplicate desktop mode is also useful for user support and education. Remote control software combined with telephone communication can be nearly as helpful for novice computer-users as if the support staff were actually there.

“Since the advent of cloud computing remote desktop software can be housed on USB hardware devices, allowing users to connect the device to any PC connected to their network or the Internet and recreate their desktop via a connection to the cloud. This model avoids one problem with remote desktop software, which requires the local computer to be switched on at the time when the user wishes to access it remotely. (It is possible with a router with direct VPN support such as a Draytek Vigor, and Wake on LAN equipment, to establish a virtual private network (VPN) connection with the router over the Internet if not connected to the LAN, switch on a computer connected to the router, then connect to it.) The common name for USB devices with the capacity to remotely recreate a user's desktop is “secure portable office.”

Remote desktop applications typically use either the Remote Desktop Protocol (RDP) or Virtual Network Computing (VNC) protocol. Other remote desktop protocols include Remote Frame Buffer Protocol, Apple Remote Desktop Protocol, NX technology, the X Window System, and the Independent Computing Architecture. In order to establish a remote connection, both the host/server and client have to support the same protocol.

Continuing in Wikipedia, the major remote desktop protocols in use are: “Virtual Network Computing (VNC)—a cross-platform protocol; Remote Desktop Protocol (RDP)—a Windows-specific protocol featuring audio and remote printing; Remote Frame Buffer Protocol (RFB)—A frame buffer level cross-platform protocol that VNC is based on; Apple Remote Desktop Protocol (ARD)—Original protocol for Apple Remote Desktop on Mac OS X machines; NX technology (NX)—a newer cross-platform protocol featuring audio and remote printing; Independent Computing Architecture (ICA)—a proprietary protocol designed by Citrix Systems; X Window System (X11)—a well-established cross-platform protocol mainly used for displaying local applications, but can also be used remotely; Rapid X Protocol (RXP)—the Graphon GO-Global protocol to communicate between the host and the client; Appliance Link Protocol (ALP)—a Sun Microsystems-specific protocol featuring audio (play and record), remote printing, remote USB, accelerated video; and Proxy Protocol (PRX)—a proprietary protocol for remote control, remote WMI, web conferencing, and screen recording, developed by Proxy Networks, Inc., formerly a product division of Juniper Networks, Inc.

### 2.3 Tablet Computers

In one of its embodiments the present invention will be seen to involve a tablet computer.

As reported in the article “AT&T says $1,000 tablets might make laptops obsolete” By Greg Bensinger appearing on the Internet at Bloomberg News for Wednesday, Aug. 25, 2010, “AT&T Inc.'s emerging devices president, who oversees the carrier's relationship with Apple Inc., said tablet computers costing as much as $1,000 might soon make many laptops obsolete.

“You're going to see those 10-inch pieces of glass become full-on computers,” Glenn Lurie said in an interview this month in Atlanta. He said he expects there to be a variety of tablet computers costing $300 to $1,000 in the next five years. The Apple iPad ranges in price from $499 to $829 . . . .

“AT&T (NYSE: T) may draw more revenue by compelling new and existing customers to buy tablet computers that will complement their smartphones. The carrier is the exclusive data-service provider for the iPad, which has sold more than 3 million units since its April 3 introduction.

Sales of tablet devices probably will grow to 23 percent of the U.S. computer market by 2015, from about 6 percent this year and less than 1 percent in 2009, said Sarah Rotman Epps, an analyst at Forrester Research Inc. in Cambridge, Mass.

“Starting in 2012, tablets will outsell netbooks, and by 2014, more consumers will use tablets than will use netbooks,” Epps, referring to the smaller, less powerful laptop-style computers, said in a report this month . . . .

“The range of tablets is already growing this year. Research In Motion Ltd. (Nasdaq: RIMM) is planning to introduce in November a tablet computer with a 9.7-inch screen and Wi-Fi capability, according to two people familiar with the company's plans. Verizon Wireless and Google Inc. (Nasdaq: GOOG) have discussed a tablet that would run on Android software, and Dell Inc. (Nasdaq: DELL) released its $299.99 Streak 5-inch tablet this month.

“There's going to be a huge number of tablets, different sizes, different functions,” Ralph de la Vega, chief executive officer of AT&T mobility, said in an interview in Atlanta. He declined to say whether AT&T would offer the planned Research In Motion device on its network.

“De la Vega said he expects sales to surge among business customers in part because tablets will be designed to connect to multiple devices, such as keyboards and cameras, that support their needs.”

The concept that Mr. De la Vega advances seems to be that the tablet computer will remain central, and will “connect to multiple devices, such as keyboards and cameras, that support the . . . [tablet's] needs. The vision of the present invention will be seen to be rather different, with the tablet being recognized to be the relatively powerless piece of Internet-connected equipment that it is, and how to leverage control of a tablet computer—which is, admittedly, in the “right place at the right time”, which means at the location of a human user—to get “more bang for the buck” from the tablet computer.

### SUMMARY OF THE INVENTION

The present invention has at least three increasingly sophisticated embodiments. All embodiments are characterized by use of a programmed modern, fourth, generation cell phone to control across the Internet a computer that is also still further connected to the Internet.

The computer can be so further communicatively connected upon the Internet to, and for purposes ranging from, (1) a game server for the playing of games, to (2) a server of maintenance programs for performing maintenance, to (3) an interactive applications server for education or recreation. The cell-phone-controlled computer is typically local to the cell phone user for application (1); local or remote to the cell phone user for application (2); and remote to the cell phone user for application (3). However, a display showing what the computer is doing (e.g., gaming, maintaining or running interactive applications)—which display may be itself connected across the internet when the computer is remote from the cell phone user—is always visible to the cell phone user. Accordingly, as will become increasingly clear as the present invention is further explained, the present invention is a method of leveraging the locally-visible-performance of a potentially remote, potentially very fast and powerful and communicatively-well-connected, computer, by use of relatively lowly cell phone.

In extremes of its third embodiment the performance of the present invention might be considered to deliver shocking results. For example, a person might depart his or her day job on a powerful workstation-class computer to his or her residence where the person has available only but a personal cell phone and a tablet, or net book, computer. In accordance with the present invention the cell phone may be used to remotely command the workstation-class computer, causing that its display should be shown (insofar as is possible) on the lowly tablet computer. In doing this, and still other things, it might be said of the present invention that never before has the product of so much remote computational and communications capability been flexibly commanded to be delivered to a local environment as by the straightforward use of a common cell phone in accordance with the present invention.

### 1. A First Embodiment of the Present Invention where a Cell Phone Controls Across the Internet a Computer that is Further Connected Upon the Internet for Gaming

At a first, rudimentary, level the present invention is embodied in (1) an Internet-connected cell phone that (A) wirelessly connects locally via the Internet TCP/IP protocol, or (B) connects across the Internet (again via the TCP/IP protocol), to (2) a processor in the form of a game console or, most typically, a computer, having a display, which processor/computer also has another, further, Internet connection to (3) a server computer for interactive gaming. The (1) cell phone is tactilely and visually local to a user, and at least (2) the display of the processor/computer is visually local to the user. Note that neither the display, nor anything else of the processor/computer such as a keyboard, should be assumed to be physically accessible by the user. The user can see the display, that is all. It might be, for a example, a computer-connected television located across a bar where the user is seated in front of the bar. The (3) server computer may be anywhere upon the Internet, and is almost invariably remote.

The purpose of the cell phone, and of its Internet protocol wireless connection to the processor/computer, is to serve as a wireless multimedia controller for the processor/computer. For example, the cell phone, running an appropriate program, can be manipulated—including surreptitiously—while located upon, for example, the lap of a student so as to control a laptop computer in front of the student. Unlike previously contemplated uses of a cell phone for computer control, the controlled functionality may be, for example, that of a multi-player game such as, by way of example, the Worlds of Warcraft [“WOW”] multi-player computer interactive game. The computer thus maintains, much in the manner of the multiple tabs or multiple pages of an Internet Browser, at least two simultaneous connections via the Internet TCP/IP protocol—one to the cell phone controller and one to the WOW game server. The “computer” can alternatively be a gaming platform such as a Sony Playstation 3 or a Microsoft Xbox 360.

A careful student of this first embodiment will come to recognize that, save for the processor/computer maintaining two connections to the Internet—one for the cell phone controller and one for the remote server—, the use of a cell phone to control across the Internet a processor/receiver, and a display to said processor receiver, that may be separated from the cell phone by mere feet distance is arguably audacious, and even radical, in its use of networked communication capability, and of the wide Internet. However, the same student may also come to feel that the purposes of this control connection are quite normal, and even mundane, and are not commensurately radical.

### 2. A Second Embodiment of the Present Invention where a Cell Phone Controls Across the Internet a Computer that is Further Connected Upon the Internet for Maintenance

A second preferred embodiment of the present invention puts the same system of (1) Internet-connected cell phone, (2) processor driving a display, and (3) server computer to a rather more sophisticated, and potentially valuable, purpose. In this second embodiment the (1) Internet-connected cell phone, is used to control (2) a processor, driving at least one display that can be made visible to the user of a cell phone, for running a maintenance program retrieved, and normally executed in real time, from a (3) remote server computer upon the Internet. In simple terms, the second embodiment of the present invention employs the lowly—but software capable, and Internet-connected—cell phone as a maintenance controller for a remote computer. The second embodiment of the present invention works as follows. A “sick” computer, such as one afflicted with a virus, may nonetheless remain quite capable of (1) receiving control via the Internet, (2) communicating data, including is present display, outward on the Internet, and (3) downloading and executing programs, such as interactive anti-virus, programs via the Internet. The problem often is simply that the person in control of this “sick” computer is not possessed of the skills to manipulate it so as to “fix” it. Although it is known to remotely control a (sick) computer for purposes of maintenance, the second embodiment of the present invention brings a new flexibility to this undertaking. The maintenance person with his (suitably programmed as a remote controller) cell phone may be anywhere, requiring only access to a display that is connected to the Internet. In actuality, it is seldom the display itself that is connected to the Internet, but rather the maintenance person has access to a computer having a display where this computer is connected to the Internet. In simple terms, the maintenance person most normally has an Internet-connected personal computer. With this, and with his/her cell phone, this maintenance person will proceed to fix the “sick” remote computer as follows.

The maintenance person accesses the remote computer from and by its IP address, and proceeds to use the cell phone as a controller (in lieu of the computer's own keyboard and mouse) to cause this remote computer—operating “blind”, and without display for this simple step if necessary—to download and execute software that will put the present contents of its display to any specified location on the Internet. This location is of course (remotely) specified by the maintained to be his/her own computer, and display. The maintained will come to see at the display of his/her own computer exactly what is displayed upon the display of the “sick” remote computer.

It is perhaps worthwhile for the reader to pause only but momentarily at this point to think what, if anything, has changed in this second embodiment from the first embodiment of the present invention. The answer is, or course, that the display that is used by, and (visually) local to, the user of the cell phone—now the “maintained”—need not be local to this display, but can be remote across the Internet.

Continuing in the second embodiment, the “maintained” that now has control of the remote “sick” computer via his/her cell phone, and who is able to see the contents of the display of that remote “sick” computer, causes with the cell phone controller this remote computer to download, and to execute, such programs as are necessary to fix the problem(s). Note that the “patient”, or “sick”, computer must simultaneously maintain communication with three separate addresses upon the Internet: (1) the cell phone for receipt of control, (2) the remote computer and its display for showing the local display contents remotely, and (3) a remote sever for purposes of downloading necessary diagnosis and correction software. As before, this communication with multiple Internet sites is straightforwardly realized as but multiple tabs, or windows, in a browser, and presents no special challenge.

### 3. A Third Embodiment of the Present Invention where a Cell Phone Controls Across the Internet a Computer that is Further Connected Upon the Internet for Running Interactive Applications

The third preferred embodiment of the present invention again uses the same Internet-connected devices, but now with changed capabilities, and for changed purposes. These purposes are expansive, and are projected to be ever more common in the future after 2010. Essentially the present invention operates in its third embodiment to substantially overcome the limitation of (1) a tablet computer commonly having but relatively weak processing power, and but a modest (albeit flexible, and commonly wireless) Internet connection, by invoking, and by coupling (2) the otherwise unused processing power of a relatively more capable, and typically greatly more capable, and faster-Internet-connected computer that is remotely situated. In one simple scenario, by use of the third embodiment of the present invention a person can leverage his or her idle workstation-class office computer to enhance the performance of his or her small tablet computer at home at night.

One typical use of the third preferred embodiment of the present invention recognizes that a tablet computer is too weak, and its Internet connection to slow, for extensive multi-tasking, whereas an office computer may have significantly greater computational power, and a “wide pipe” to the Internet. A person at home with his or her (1) Internet-connected cell phone, and (2) Internet-connected tablet computer with its screen, uses the cell phone to control (3) a remote, office, computer that is preferably of significant computational power, with a high performance connection to the Internet. Say that the person with the (2) tablet computer desires to rampage through a lot of data on the Internet, for example it is desired to “flip through” substantial portions, or all, of a number of movies without delay between selections, with fast forwarding and/or with pre-storage of movies pending viewing, and archiving of selected portions or entire movies after viewing. In short, the person desires to be a “power user”. Now certainly the tablet computer, and its Internet connection, can suffice get one movie at a time, but it is going to be impossible in many respects to sustain multiple simultaneous downloads with the tablet computer, especially while task switching within, and between, viewed movies with great vigor.

Enter the office computer and its broadband Internet connection, otherwise sitting unused. The person with the tablet uses his or her cell phone to control both the office computer and, so that some feedback may be obtained, the local tablet. Essentially the cell phone is sending commands to two URL's at once—one for the local, tablet, computer and another for the remote, office, computer. The cell phone may direct both computers to, by way of example, start downloading to local storage full-length movies 1, 2, 3. This is a hopeless task for the tablet computer, which may not even have sufficient storage capacity to hold three full length movies. Not so the office computer, which proceeds apace to perform as directed. Note however that, consistent with the present invention, the computers—both computers—that communicate with the cell phone (each at its respective Internet URL, have not only a path to the cell phone, but also at least one other path—multiple paths—open to the Internet.

Now—and this is a bit tricky—the person cancels the tasks at the tablet computer by using the normal tablet computer controls, typically a keyboard and a mouse. The cell phone controller is not involved in this step. Meanwhile, the tasks continue apace at the office computer. The tablet computer is free to browse the Internet, or whatever. However, the primary interest of our user has been, and is, to “check out” the three full length movies, and more. Now these movies, retrieved to the office computer, could be, under remote control from the cell phone, “force fed” by the office computer across the Internet to the tablet computer. But why bother? The normal controls—the keyboard and the mouse—of the tablet computer are simply used, with a window in a browser, to access files on the office computer (which, of course, maintains a link to the Internet, and runs a program by which it may be continuously securely accessed by an authorized correspondence which is, in this case, the tablet computer. The tablet computer looks (over the Internet) to the appropriate directories on the remote office computer and, voila, the 3 movies of interest are right there! Miracle of miracles, exactly what the person at the tablet computer wants to see, and all that in the future he/she may want to retrieve and to see, is—proper control with the cell phone being effected—right there at the remote office computer. The office computer essentially becomes a server/re-server for the tablet computer. Mind you, the speed of the Internet connection to the tablet computer is not increased by this system, and by these steps. But the tablet computer essentially becomes a satellite to the office computer, which office is computer is remotely controlled by the cell phone from the site of the tablet computer. The tablet computer effectively has to do very little “work”, and task switching. It can simply serve as a “dumb download device”, with most information (e.g., the movies) that it desires, or comes to desire, being made available to it from, and by, the remote office computer.

There is a price for the coupling of the remote and powerful office computer to the limited, but local, tablet computer. First, both computers must be on, and both handle a good deal of the same data (e.g., the movies). Second, the Internet is used once to bring each movie from its source servers upon the Internet to the office computer, and again from the office computer to the ultimate-destination tablet computer. This “double transfer”—prospectively of voluminous data (e.g., the movies)—is arguably wasteful. However, many internet serve providers do not charge for Internet bandwidth consumed, and the third embodiment of the present invention certainly leverages both cell phone and computer hardware, and Internet communications, resources to provide the best possible experience to the user of a mere tablet computer, being an inexpensive device of low performance and, most often, limited communications bandwidth.

These and other aspects and attributes of the present invention will become increasingly clear upon reference to the following drawings and accompanying specification.

### BRIEF DESCRIPTION OF THE DRAWINGS

FIG. 1 is a diagrammatic perspective view of a preferred first embodiment of a system for the cell-phone-based remote control of an Internet-connected computer in accordance with the present invention.

FIG. 2 is a detail perspective view of the hand and fingers activation of a cell phone in the first embodiment of the present invention previously seen in FIG. 1.

FIG. 3 is a plan view of an exemplary touch screen on the cell phone in the first embodiment of the present invention previously seen in FIG. 1.

FIG. 4 is a plan view at expanded scale of an exemplary first screen on the cell phone in the first embodiment of the present invention previously seen in FIG. 1.

FIG. 5 is a plan view at expanded scale of an exemplary second, touch, screen on the cell phone in the first embodiment of the present invention previously seen in FIG. 1.

FIG. 6 is a plan view of a part of a screen presented by a client process, and shown upon the screen of, a computer that is remotely controlled by a cell phone for gaming in accordance with the first embodiment of the present invention previously seen in FIG. 1.

FIG. 7 is a diagrammatic perspective view of a preferred first embodiment of a system for the cell-phone-based remote control of an Internet-connected computer in accordance with the present invention.

FIG. 8 is a flow chart of the process of the present invention for use of a cell phone as a remote controller over the Internet for a computer that is also, and further, connected to the Internet, such as for interactive gaming and/or remote maintenance and/or still other processes.

### DESCRIPTION OF THE PREFERRED EMBODIMENT

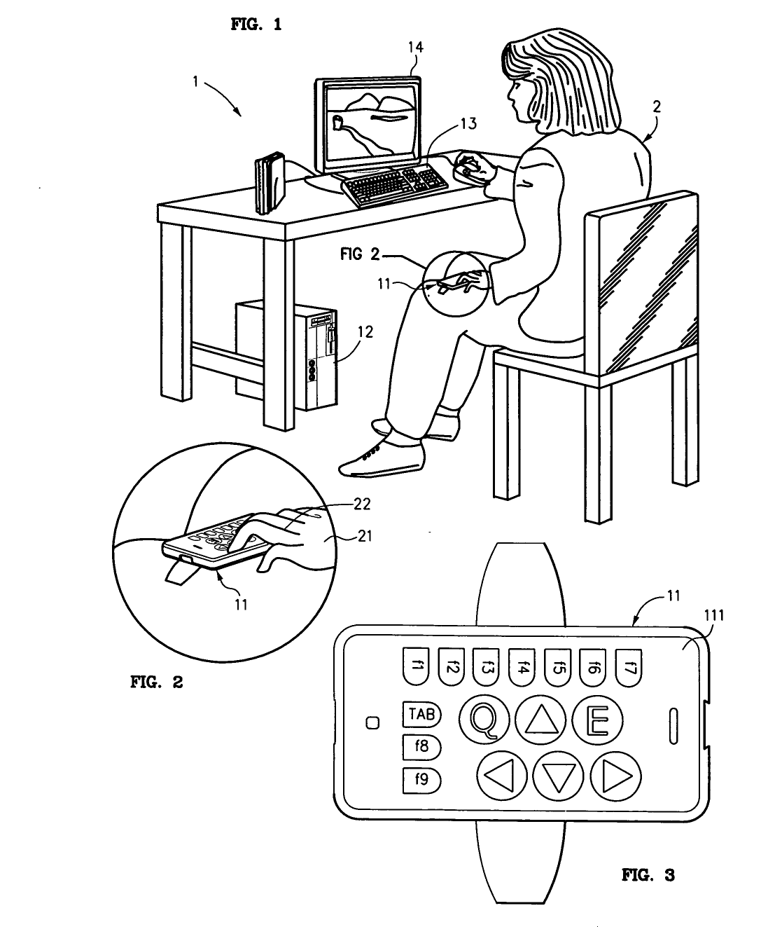

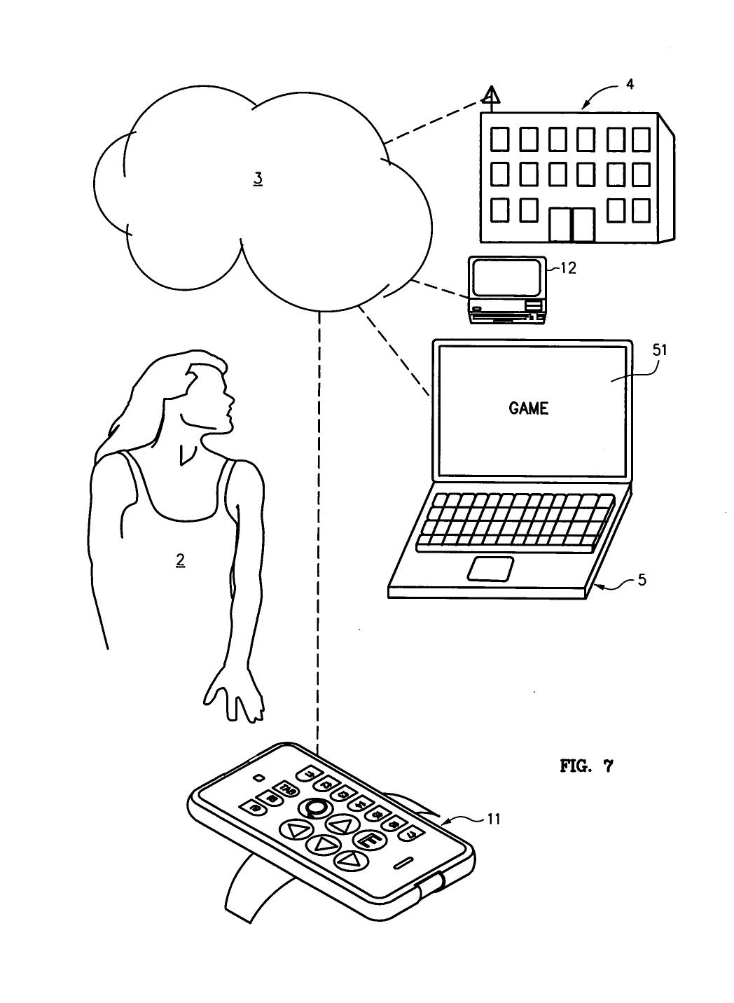

A diagrammatic perspective view of a preferred first embodiment of a system 1a for the cell-phone-based remote control of an Internet-connected computer in accordance with the present invention is shown in FIG. 1. A user 2 (not part of the invention) activates with the hand an fingers a cell phone 11 that may be held for convenient access in, and by, the device taught within companion patent application Ser. No. 12/804,339 for HOLDING A CELL PHONE FOR ROTATIONAL MOVEMENT UPON THE LAP OF A SITTING PERSON to the selfsame inventor as is the present application. The cell phone 11 is wirelessly connected to the Internet (best seen in FIG. 7) for control of the computer 12. In the first embodiment of system 1a in accordance with the present invention, computer 12 and its keyboard 13 and its display 14 are local to the user 2.

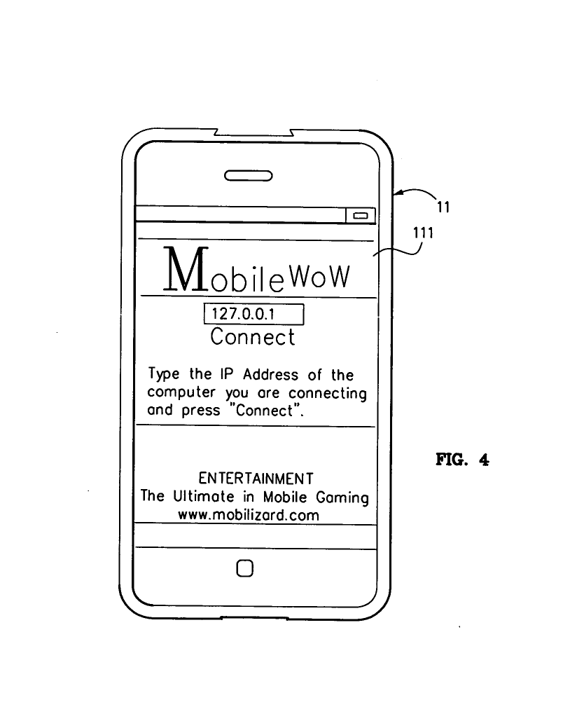

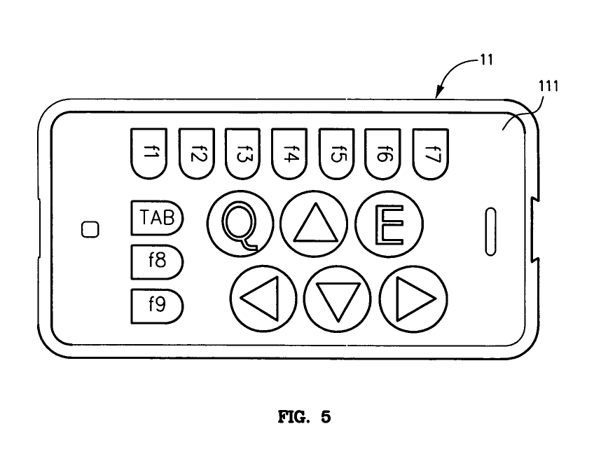

The activation of the cell phone 11 by the user 2 is shown in detail perspective view, including the hand 21 and fingers 22 (not part of the invention) in FIG. 2. A plan view of an exemplary touch screen 111 on the cell phone 11 in the first embodiment of the present invention (previously seen in FIG. 1) is shown in FIG. 3. The shown “pushbuttons” Q, Δ, E, and [symbol] , ∇, [symbol] are those used in the game World of Warcraft [“WoW”] from Blizzard Entertainment. The pushbuttons f1 through f8 can be assigned as desired to functions within this WoW game, as can the “TAB” key. Results of the game play entered on the touchscreen 111 of the cell phone 11 appear on the screen 14 of the computer 12 (both shown in FIG. 1), which computer 12 is connected across the Internet to the WoW game servers on the Internet at Blizzard Entertainment.

As background, World of Warcraft, often referred to as WoW, is a massively multi-player online role-playing game (MMORPG) by Blizzard Entertainment, a subsidiary of Activision Blizzard. With more than 11.5 million monthly subscriptions in December 2008, World of Warcraft is currently the world's most-subscribed MMORPG, and holds the Guinness World Record for the most popular MMORPG by subscribers. In April 2008, World of Warcraft was estimated to hold 62 percent of the MMORPG subscription market. Clearly if the cell phone running software, and communicating across the Internet

A plan view at expanded scale of an exemplary first screen on the cell phone 11 in the first embodiment of the system 1a of present invention—previously seen in FIG. 1—is shown in FIG. 4. The user 2 must enter the (then) Uniform Resource Locator (“URL”), or Internet Protocol address (“IP address”), of the computer which is being addressed upon the Internet for purposes of remote control. In the illustrated example of FIG. 4 this IP address is, quite clearly, 127.0.0.1.

Similarly, a plan view at expanded scale of an exemplary second, touch, screen 111 on the cell phone 11 in the first embodiment of the system 1 of the present invention (previously seen in FIG. 1) is again shown in FIG. 5.

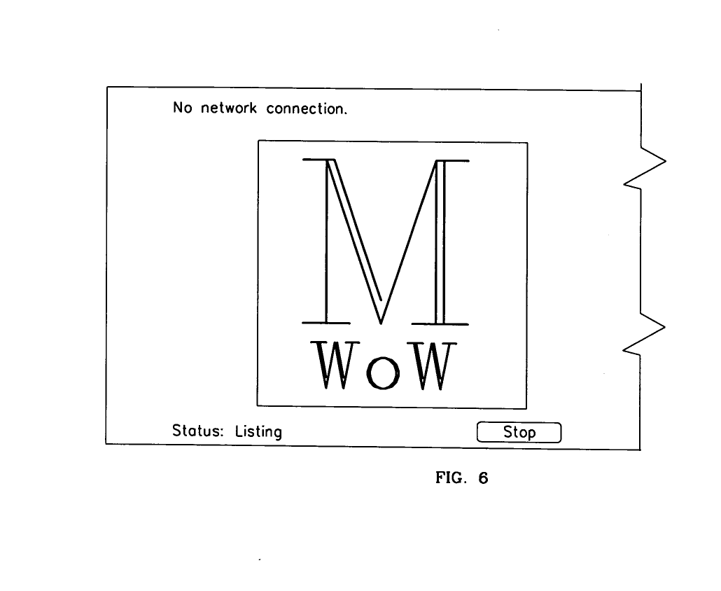

A plan view of a part of a screen presented by a client process, and shown upon the screen of, a computer that is remotely controlled by a cell phone for gaming in accordance with the first embodiment of the present invention (previously seen in FIG. 1) is shown in FIG. 6. The client process is running, and when the cell phone connects (via a local router, or the Internet), then the “No network connection” will change to “Cell phone controller connected”, or some like phrase.

A diagrammatic perspective view of further preferred embodiment of systems 1b, 1c in accordance with the present invention is shown in FIG. 7. In each case a user 2 (not part of the present invention) activates a cell phone 11 to effect remote control of a first Internet-connected computer 12. The computer 12 may be, and typically is, quite powerful, and the bandwidth of its connection to the Internet 3 is typically broad and very fast.

This computer 12 is directed to connect, and does connect, across the Internet 3 to some site 4 providing servers, and delivering some applications function from, by way of example and not in way of limitation, (1) gaming, to (2) maintaining of computer 12, to (3) the presentation on computer 12 of anything from education to entertainments. In other words, both computers 5 and 12 can at times be running gaming or other applications, and the cell phone 11 serving as remote controller can variously connect to each, one at a time. One scenario where this might be fruitful is if the user 2 of cell phone 11 was to first connect to computer 12 and start the running of a lengthy maintenance program, and then alternatively connect with the same cell phone 11—still functioning as a remote controller but now with a screen display suitable for gaming as is illustrated in FIG. 7—to the computer 11 for the purpose of interactive gaming. Note that computers 5, 11 connect to the Internet as well as tom at tines, the cell phone 11,

Resultant to control of the computer 12 effected by the user 2 through the cell phone 11 the computer 12 delivers some results, normally a real time video display, to some screen that is visible to the user 2. In FIG. 7 this is suggested to be the screen 51 integral to computer 5. This computer 5 may be, and typically is, a simple net book, or a tablet computer, having a fast connection to Internet 3 and little else. Nonetheless to the simplicity, and low cost, of the computer 5, it can display the results realized in the computer 12—suggested to be of workstation class and quite powerful and expensive—under control of the cell phone 11 and the user 2. In this manner the simple instrumentality of the Internet-connected programmable, fourth generation (or higher) cell phone 11, suffices to leverage the tremendous power of the remote computer 12, and through it the remote servers 14, into the local environment of the user 2.

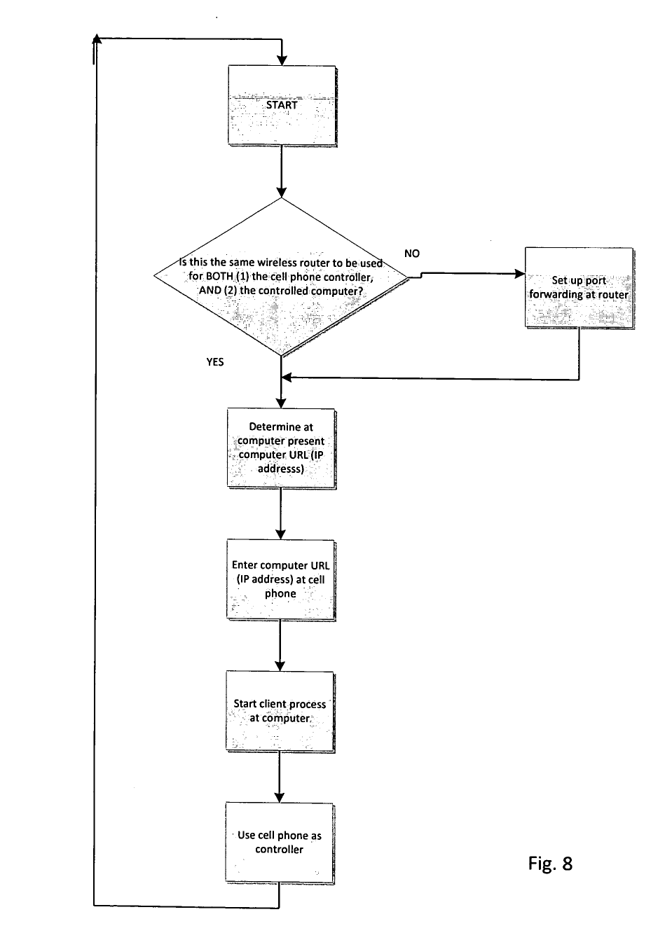

A flow chart of the software executed by the cell phone 11 shown in FIGS. 1-7 in realization of the first embodiment system 1a of the present invention is shown in FIG. 8. Note that if both the computer that is controlled, and the cell phone that will be used to control it, are connected through the same wireless router then the step of setting-up of a URL, or IP address, as shown in FIG. 4 may be bypassed. Otherwise, the URL, or IP address, of the non-local controlled computer must be (1) known and (2) entered, as shown in FIG. 4.

If the computer is not connected, normally wirelessly, to the same local router that is being used by the cell phone serving as remote controller than port forwarding must be configured on the router. This operation is substantially identical for all wireless routers, and is now explained, by way of example, in the specific context of configuring port forwarding on Linksys router.

The process requires (1) a wireless router, by way of example the Linksys router running Linksys firmware, (2) the IP address of host requiring port forward, and (3) the port number and protocol (UDP or TCP). The process commences by going to the administration page of the router and entering the router's IP address in the browser address bar. For example, if the router's IP address is 192.168.1.1 then “http://192.168.1.1” must be entered.

The user should then enter his/her user name and password when prompted. Once logged in, the user should select the applications and gaming tab at the top of the page. From there “port range forwarding” is selected.

In the top row first box, the name of the service that the port is being forward to—e.g. torrent or apache—should be entered. In the second and third box, the port number to which the user wishes to forward is selected, and the protocol for this port is selected in the drop down menu. If the user is uncertain of the protocol, he or she should select both. Under “IP address”, the user should enter the IP address of the host to which the traffic is being forwarded. If this port forwarding is for torrents—which is not the case with the present invention—then the IP address will be the local machine's address. Finally, the user should check enable and save all settings.

The local wireless connection to both (1) the cell phone 11, and (2) the computers 5 and 12—shown in FIG. 7—either or some or all, need not be in accordance with any particular wireless communication standard, but can be any of IEE802, or WiFi, or Bluetooth, or still other wireless communications standards. Clearly if the computers 5, 12, or either of them as its then being controlled by cell phone 11, is not to a same wireless communications router, then the URL, or IP address, of the computer that is being controlled must be entered (even should it be local), in accordance with FIGS. 4 and 7.

According to these variations, and still others within the skill of a practitioner of the digital electronic systems and system communication arts, the present invention should be considered in accordance with the following claims, only, and not solely on accordance with those embodiments within which the invention has been taught.

What is claimed is:

1. A system for remotely controlling a computer across the Internet using a mobile phone, the system comprising:
a programmed mobile phone responsive to user input to furnish control across a persistent Internet connection to a computer;
wherein the computer both (1) accepts control from the mobile phone across the persistent Internet connection, and (2) further concurrently connects across the Internet to at least one server so as to run software interactively with the server to produce a display that is visible to the user.

2. The system according to claim 1
wherein the Internet-connected computer is local to the user.

3. The system according to claim 1
wherein the Internet-connected computer is not local to the user, but is situated remotely and
wherein the display visible to the user is local to the user, and is driven remotely across the Internet from the computer.

4. The system according to claim 1
wherein the computer connects to the at least one server across the Internet to run gaming software; and
wherein the display that is visible to the user shows progress in a computer game.

5. The system according to claim 1
wherein the computer connects to the at least one server across the Internet to run maintenance software; and
wherein the display that is visible to the user shows progress in maintaining the Internet-connected computer

6. The system according to claim 1
wherein the computer connects to the at least one server across the Internet to receive entertainment and educational content; and
wherein the display that is visible to the user shows the entertainment and educational content.
